(19) United States
(12) Patent Application Publication
(10) Pub. No.: US 2025/0124022 A1
(43) Pub. Date: Apr. 17, 2025

(54) GENERATIVE ARTIFICIAL INTELLIGENCE FORM BUILDER

(71) Applicant: Microsoft Technology Licensing, LLC, Redmond, WA (US)

(72) Inventors: Reshmi GHOSH, Somerville, MA (US); Shaily Jignesh FOZDAR, New York City, NY (US); Tianyi YAO, Somerville, MA (US); Huitian JIAO, Snoqualmie, WA (US); H M Sajjad HOSSAIN, Everett, WA (US); Jiangning CHEN, Everett, WA (US); Dario Kikuchi BERNAL, Cambridge, MA (US); Tianwei CHEN, Atlanta, GA (US); Irene Rogan SHAFFER, Cambridge, MA (US); Zhongzhong LI, Beijing (CN); Junlin WU, Beijing (CN); Dongxiao YANG, Beijing (CN); Weiwei SHI, Beijing (CN); Yuanquan HU, Beijing (CN); Genglin HUANG, Beijing (CN); Sheikh Sadid Al HASAN, Weymouth (CN)

(21) Appl. No.: 18/487,009

(22) Filed: Oct. 13, 2023

(51) Int. Cl. G06F 16/242; G06F 16/21

(52) U.S. Cl. CPC G06F 16/2428; G06F 16/211

(57) ABSTRACT

A system classifies an intent based on a received prompt and identifies system-provided prompts based on the intent. The system inputs the system-provided prompts and the received prompt to a generative artificial intelligence model, wherein the generative artificial intelligence model outputs form items corresponding to the received prompt and the system-provided prompts, the form items including form prompt items and form response items. The system converts the form items into the renderable form presentable in a user interface, wherein the renderable form includes the form prompt items and the form response items.

### BACKGROUND

Various software vendors provide form builder software applications that assist users with creating various online forms, such as surveys, quizzes, polls, etc. In virtual classroom settings, form builder applications can be used to create a quiz or exam, collect feedback from teachers and parents, or plan class and staff activities. In business or government organizations, form builder applications can be used to collect customer feedback, measure employee satisfaction, improve your product or service, or organize company events. Such applications can also be used for other types of forms and in other environments.

### SUMMARY

In some aspects, the techniques described herein relate to a method of generating a renderable form, the method including: classifying an intent based on a received prompt; identifying system-provided prompts based on the intent; inputting the system-provided prompts and the received prompt to a generative artificial intelligence model, wherein the generative artificial intelligence model outputs form items corresponding to the received prompt and the system-provided prompts, the form items including form prompt items and form response items; and converting the form items into the renderable form presentable in a user interface, wherein the renderable form includes the form prompt items and the form response items.

In some aspects, the techniques described herein relate to a system for generating a renderable form, the system including: one or more hardware processors; an intent classifier executable by the one or more hardware processors and configured to classify an intent based on a received prompt; a system prompt constructor executable by the one or more hardware processors and configured to identify system-provided prompts based on the intent, wherein the system-provided prompts and the received prompt are input to a generative artificial intelligence model, wherein the generative artificial intelligence model outputs form items corresponding to the received prompt and the system-provided prompts, the form items including form prompt items and form response items; and a schema generator executable by the one or more hardware processors and configured to convert the form items into the renderable form presentable in a user interface, wherein the renderable form includes the form prompt items and the form response items.

In some aspects, the techniques described herein relate to one or more tangible processor-readable storage media embodied with instructions for executing on one or more processors and circuits of a computing device a process for generating a renderable form, the process including: classifying an intent based on a received prompt; identifying system-provided prompts based on the intent; inputting the system-provided prompts and the received prompt to a generative artificial intelligence model, wherein the generative artificial intelligence model outputs form items corresponding to the received prompt and the system-provided prompts, the form items including form prompt items and form response items; and converting the form items into the renderable form presentable in a user interface, wherein the renderable form includes the form prompt items and the form response items.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates a form building workflow using an example generative artificial intelligence form builder.

FIG. 2 illustrates a form refinement workflow using an example generative artificial intelligence form builder.

FIG. 3 illustrates a multi-section form generated using an example generative artificial intelligence form builder.

FIG. 4 illustrates an example generative artificial intelligence form builder 400.

FIG. 5 illustrates an example offline evaluation pipeline.

FIG. 6 illustrates example operations for building a renderable form using a generative artificial intelligence form builder.

FIG. 7 illustrates an example computing device for use in implementing the described technology.

### DETAILED DESCRIPTIONS

Form building software applications (“form building apps”) can assist users in generating new forms, such as online surveys, quizzes, polls, application forms, registrations, etc. Typically, a user would manually draft form content from scratch through a form building interface. Manual form drafting can involve activities like drafting text for prompts, dragging and dropping form controls into the form, specifying possible answers to prompts for multiple choice questions, defining question types and formats, organizing questions into sections, handling accessibility and language aspects, etc. However, while form building may initially appear to be a relatively simple activity, building robust useful forms can quickly become unexpectedly complicated in a variety of ways. For all but the simplest forms, the complexity of developing appropriate content for a specific domain, instrumenting the form with appropriate data types and control types, connecting the form components with backend logic, applying appropriate formatting, and organizing the form content within the form (e.g., grouping questions within different form sections) can become challenging, especially for a user without significant technical experience in building online forms.

Furthermore, many form building users are not well-trained to develop effective online forms. Best practices for building forms (e.g., in an education or corporate environment), such as content diversity, deliberate repetition or non-repetition, appropriate ordering of questions and possible answers, and imposing a coherent question flow, can contribute additional levels of complexity to the form building activity. Without sufficient training or intelligent assistance, a user may build ineffective forms or may become so frustrated with the process that the user abandons building their own online forms.

The building of online forms also presents an accessibility concern. Some users attempting to build online forms may have physiological and/or intellectual constraints (e.g., degraded vision, typing difficulties, tracking difficulties, organizational deficits, language barriers) that make the form building activity more difficult than for others. Without intelligent assistance, such users may be unable or unmotivated to attempt to build their own online forms.

Accordingly, the described technology applies generative artificial intelligence (AI) to assist a user in building a new form. The user can submit a user prompt (e.g.,” “Create an employee satisfaction survey”) to a generative-AI-assisted form builder, which validates the user prompt and produces a set of robust system prompts to be submitted to a generative AI model. The generative AI model outputs generated content in the form of one or more questions, answers, formats, controls, data types, control types, sections, etc. The generated content output by the generative AI model is validated and rendered into a form schema that is responsive to the user prompt. The user can open the form (specified by the form schema) in the form builder to add/substrate/modify/refine the form through one or more subsequent iterations until the user is satisfied with the final form.

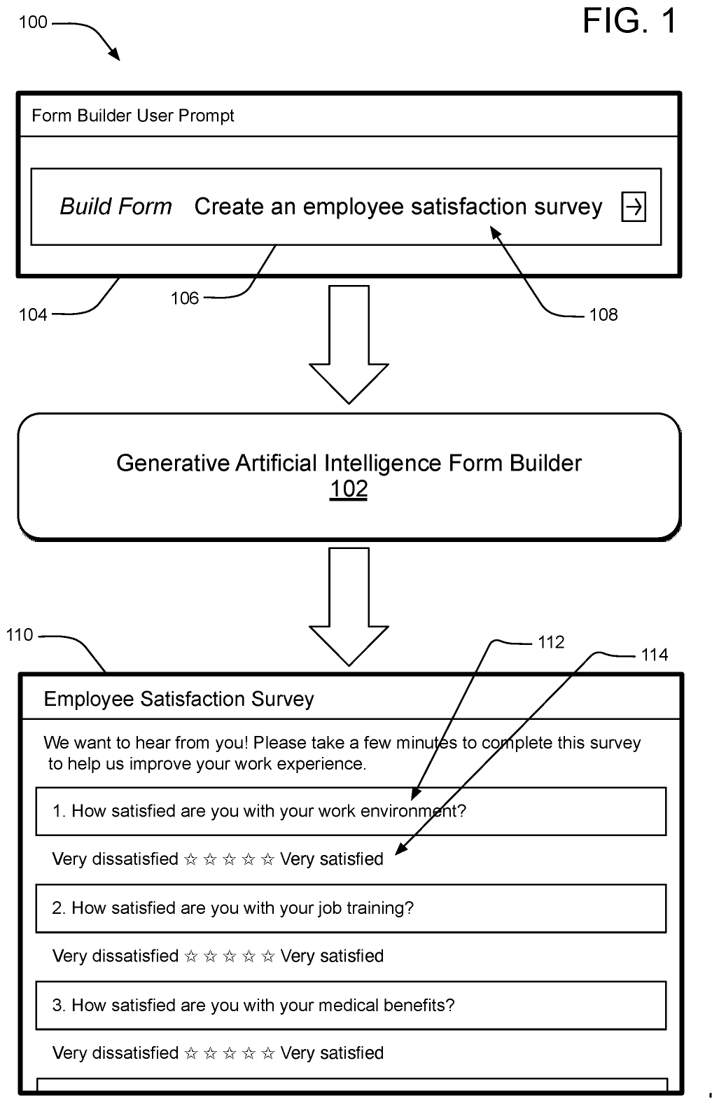

FIG. 1 illustrates a form building workflow 100 using an example generative artificial intelligence form builder 102. The form building workflow 100 presents a user interface object 104 including a form builder user prompt input field 106, which accepts a user input allowing the user to specify the kind of form they wish to generate and providing a user prompt 108 directed to that intent. In the illustrated example, the user prompt states that the user wishes to “Create an employee satisfaction survey.”

The user prompt 108 is submitted to the generative artificial intelligence form builder 102, which generates a renderable form 110 with various form prompt items (see, e.g., the text of a form prompt item 112) and form response items (see, e.g., the text of a form response item 114). In the illustrated example, the form response item 114 is a dynamic object configured to receive input via a user interface and communicate a user's response back to another process to collect, analyze, summarize, communicate, and/or present the responses. In some applications, the form prompt item 112 may also be a dynamic object (e.g., capable of annotation, dynamic formatting, visual effects).

In various implementations, the generative artificial intelligence form builder 102 performs several operations, including one or more of the following:
Validating the user prompt 108 (also referred to as a received prompt) against a predefined policy;
Classifying the intent of the user prompt 108;
Identifying system-provided prompts based on the classified intent;
Producing form items (e.g., including form prompt items and form response; items) corresponding to the user prompt 108 and the system-provided prompts;
Validating the form items; and
Converting the form items into a renderable form 110 that is presentable in a user interface against a predefined policy.

In some implementations, the predefined policy relates to one or more dimensions of Responsible AI (RAI), which may include data and system operations, explainability and interpretability, accountability, consumer protection, bias and fairness, robustness, policy and governance, strategy and leadership, people and training, AI system documentation, procurement practices, and other dimensions. Other types of policies may be applied, including internal enterprise policies, legal compliance policies, etc.

In one implementation, the renderable form is in JSON format, although other form formats may be employed, including PDF format, Excel format, and other public domain and proprietary formats. The renderable form can be presented to a user via a user interface so that the user's responses can be collected and processed by other services.

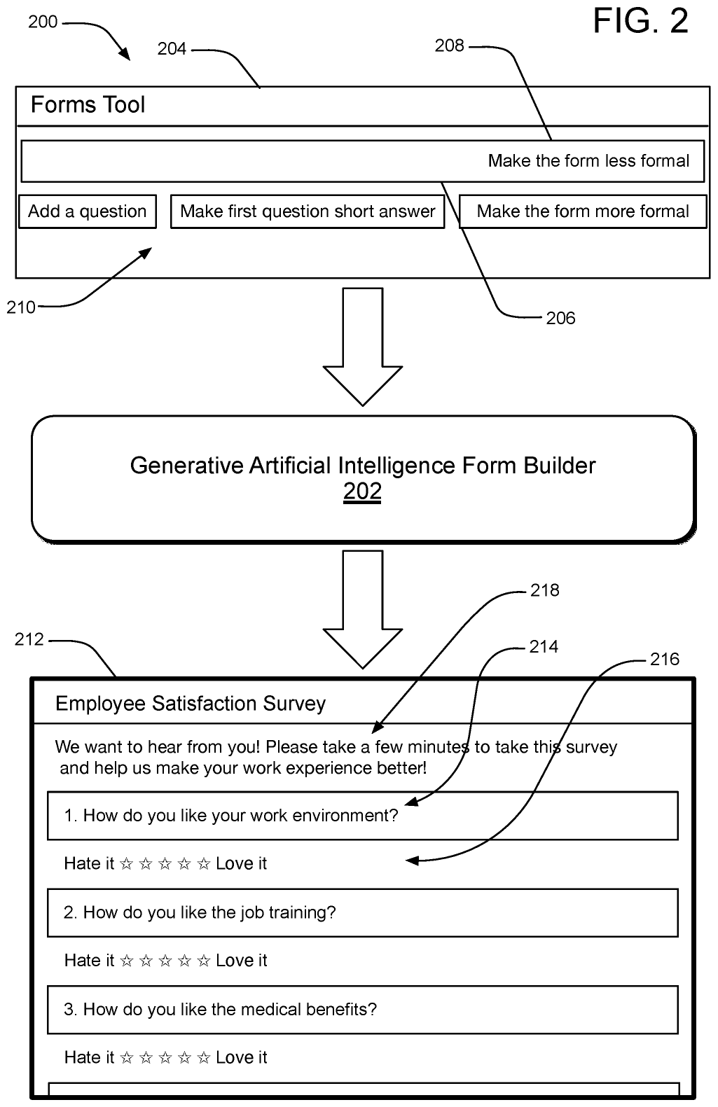

FIG. 2 illustrates a form refinement workflow 200 using an example generative artificial intelligence form builder 202. Generally, the form refinement workflow 200 is intended to refine an already existing or already generated form. For example, in one implementation, a user wishing to generate a renderable form can run through the workflow of FIG. 1. After reviewing the renderable form generated by the workflow of FIG. 1, the user may decide that the language is too formal for the user's intended audience. Alternatively, the user may import a previously generated form or another form template into the generative artificial intelligence form builder 202 with the desire to refine the existing form. In either case, the user can provide a refinement instruction to refine the original renderable form into a refined renderable form.

As shown in FIG. 2, the form refinement workflow 200 presents a user interface object 204 including a form builder refinement input field 206, which accepts a user input allowing the user to specify the refinement they wish to apply. In the illustrated example, the user has input a refinement instruction 208 to “Make the form less formal.” Other available options are listed along location 210, although other refinement instructions may also be employed, whether through the selection of predefined instructions, text input, or other methods.

The refinement instruction 208 is submitted to the generative artificial intelligence form builder 202, which generates a refined renderable form 212 with various refined form prompt items. The previously input user prompt and system-provided prompts may be resubmitted to the generative artificial intelligence form builder 202, or the generative artificial intelligence form builder 202 may cache these inputs from the previous iteration.

When comparing the renderable form 110 from FIG. 1 to the refined renderable form 212 of FIG. 2, it is apparent that the generative artificial intelligence form builder 202 has modified the form items to be less formal. For example, the text of the form prompt item 112 from FIG. 1 has been changed from “How satisfied are you with your work environment?” to “How do you like your work environment?” in form prompt item 214, and the text of form response item 114 has been changed from “Very dissatisfied ⋆⋆⋆⋆⋆ Very satisfied” to “Hate it ⋆⋆⋆⋆⋆ Love it” in form response item 216. Also, note that the preliminary text 218 has been modified to be less formal compared to that of FIG. 1.

Such refinement iterations can be repeated with different refinement instructions to achieve a final renderable form that satisfies the user.

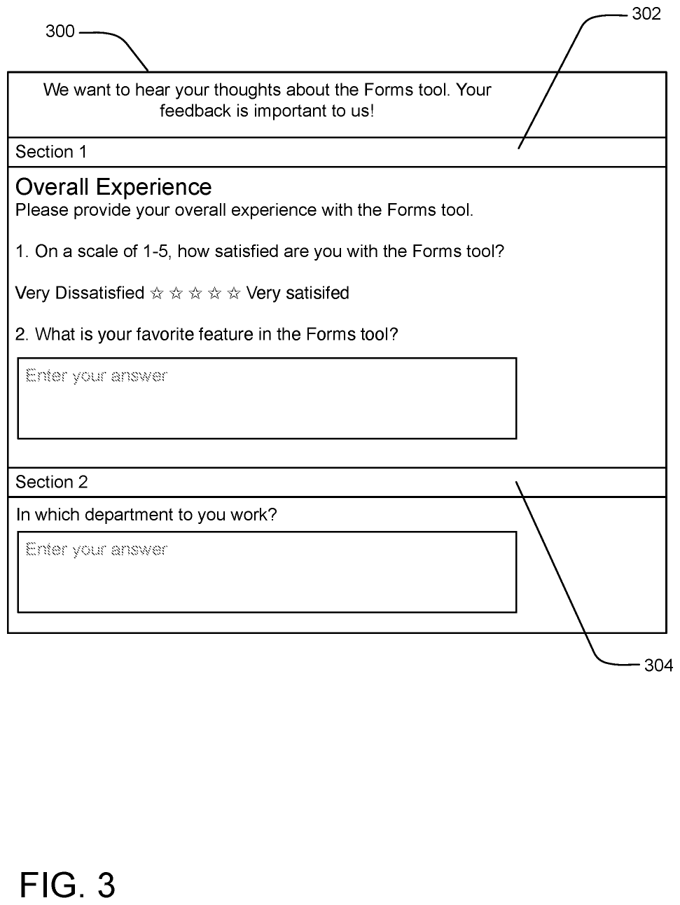

FIG. 3 illustrates a multi-section form 300 generated using an example generative artificial intelligence form builder. The multi-section form 300 is an example of a renderable form that has been instrumented according to formatting parameters, although other formatting parameters may be created and applied. For example, a generative artificial intelligence model receives various prompts and instructions to output form prompt items and form response items. The generative artificial intelligence model can also identify and/or generate format items that include formatting parameters, such as section parameters, text formatting parameters, form formatting parameters, formatting controls (e.g., filtering or sorting controls), and other formatting parameters.

As shown in FIG. 3, the multi-section form 300 includes two section items (section item 302 and section item 304) separating related groups of form prompt items and form response items. Section dividers help organize a long form to make the form more user-friendly. The section items can be represented in the renderable form, as formatting instructions in JSON or in other renderable form formats.

In one implementation, formatting parameters in system-provided prompts, a user prompt, and/or refinement instructions can trigger the generative artificial intelligence model to output formatting items along with the form prompt items and form response items. For example, a system-provided prompt may specify splitting up less related format items into different sections or limiting the number of format items per section to a specified number in an effort to make a longer form more accessible/understandable to a user. Formatting may include section titles, section descriptions, and other formatting parameters (e.g., fonts, font sizes, paragraph formatting, form themes, language).

In another implementation, a schema generator can generate the formatting items into the renderable form when converting the form items to a renderable form format. For example, the schema generator can be configured to separate a certain number of format items into different sections. The schema generator may also be able to measure the similarity of format items so as to group similar items into the same groups. In some implementations, schema generation can be orchestrated by interaction with a generative AI model, a large language model, a generative pre-trained transformer, etc. In such implementations, the system prompt constructor, or other components of the generative artificial intelligence form builder (e.g., in a separate operation) can provide specific instructions to the model(s) to output the renderable form in a specific renderable format, such as JSON, PDF, HTML, Markdown, and other formats.

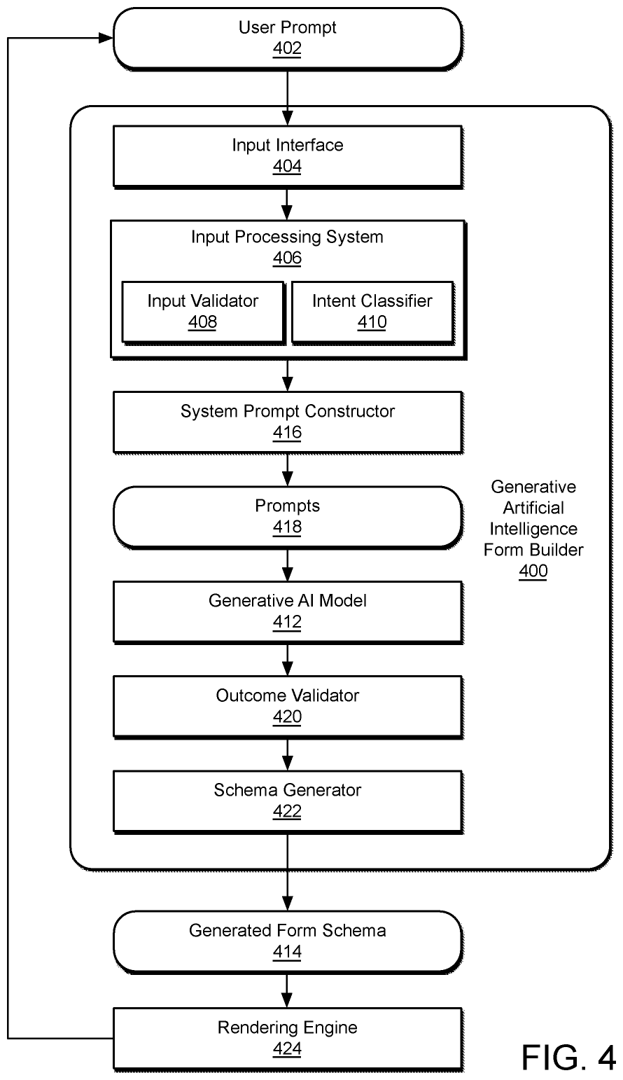

FIG. 4 illustrates an example generative artificial intelligence form builder 400. A user prompt 402 is input to the generative artificial intelligence form builder 400 via an input interface 404 (e.g., a communication interface, a user interface rendered in a computer display). An input processing system 406 receives the user prompt 402 for validation and intent classification.

An input validator 408 of the input processing system 406 validates the user prompt 402 for compliance with a predefined policy prior to inputting the system-provided prompts and the received prompt to the generative artificial intelligence model. In one implementation, the input validator 408 validates the received prompt against one or more dimensions of Responsible AI, although other policies may be applied. Examples of such dimensions may include language detection, content moderation, submission to validation services, etc. For example, in one implementation, the input validator 408 evaluates the input (e.g., user prompt, system-provided prompts) to eliminate or reduce harmful content from the prompts passed and aligns the intention of the customer with the forms creation scenario, rather than prompt injection (jail break) or any invalid user prompts. The input validator 408 may employ Azure's Language Detector, Azure Content Moderator, and GuardList, as well as a robust custom-made Forms Intent Classifier.

In some implementations, the system-provided prompts are often pre-validated and may not require subsequent validation by the input validator 408. Alternatively, whether pre-validated or not, the system-provided prompts may also be validated by the input validator 408. For example, in order to provide a robust validation for a variety of form-building scenarios, the input validator 408 can also validate the system-provide prompts in an effort to reduce or eliminate the risks of generating offensive output.

An intent classifier 410 of the input processing system 406 receives the user prompt 402 and evaluates the user prompt 402 to classify the intent of the user prompt 402. In one implementation, a large language model (LLM) inputs the user prompt 402 and predicts the intent of the user prompt 402 for the purposes of identifying system-provided prompts to submit to a generative AI model 412 that generates form items for the renderable form (represented by a generated form schema 414). Given the user prompt 402, the task of predicting an intent (represented by a text-class label) to the user prompt 402 is transformed to generating a predefined textual response (e.g., positive, negative, etc.) conditioned on the user prompt 402 using the large language model. This example implementation may be termed prompt-based in-context learning. In such an implementation, the text-class label represents the intent discerned by the LLM for the user prompt 402.

A system prompt constructor 416 uses the intent produced by the intent classifier 410 to construct one or more system-provided prompts, which are intended to supplement/refine the user prompt 402 that is to be input to the generative AI model 412 in order to direct the generation of the renderable form. In one implementation, the system prompt constructor 416 uses the classified intent to look up system-provided prompts in a prompt template library (not shown). For example, the system prompt constructor 416 can search a prompt template library based on the intent and identify the system-provided prompts from the library that correspond to the intent. In one implementation, the appropriate system-provided prompts may be selected using a similarity measurement or some other method of identifying system-provided prompts that are well associated with the intent.

In another implementation, the system-provided prompts may be dynamically generated, such as by a generative artificial intelligence model. The validated user prompt and/or the intent can be submitted to the generative artificial intelligence model, which outputs prompts responsive to those input parameters (e.g., validated user prompt 402 and/or the intent). In such implementations, the resulting prompts may also be validated in a manner similar to that performed by the input validator 408.

The system prompt constructor 416 outputs the selected system-provided prompts, which can be combined with the user prompt (see prompts 418). The prompts 418 are submitted to the generative AI model 412 to generate form items (e.g., form prompt items, form response items, form format items).

In some implementations, the form items output by the generative AI model 412 are input to an outcome validator 420, which validates the output form items against one or more dimensions of Responsible AI, although other policies may be applied. Aspects of validation may include question diversity, bias removal, question count, offensive language/concept filtering, etc. Examples of such dimensions may also include language detection, content moderation, submission to validation services, etc. In a manner similar to that of the input validator 408, the outcome validator 420 evaluates the generative AI model 412 to eliminate or reduce harmful content in the output and aligns the intention of the customer with the forms creation scenario, rather than prompt injection (jail break) or any invalid asks. The generative AI model 412 may employ Azure's Language Detector, Azure Content Moderator, and GuardList, as well as a robust custom-made Forms Intent Classifier.

A schema generator 422 receives the validated form items and converts the form items into the renderable form presentable in a user interface. For example, the schema generator 422 translates the form items (e.g., form prompt items, form response items, form format items) into JSON format embodied as a generated form schema 414 and configured to be rendered as a digital form (e.g., as an online form). Other form formats are contemplated, such as PDF, HTML, Markdown, and other formats. A rendering engine 424 renders the form in a user interface, where it can be reviewed by the authoring user or completed by a user answering the form questions.

In some scenarios, the authoring user may review the generated form as it is rendered in a user interface and desire to refine the form to change the number of questions, to change the tone (e.g., more formal/informal), to obtain a different set of question, to change the format of one or more questions (e.g., changing a question from multiple choice to short answer), etc. Accordingly, the authoring user can iterate back to the input phases and specify certain refinements to the form (see, e.g., the workflow illustrated in FIG. 2). Whether by selecting refinement options or by entering specific refinement instructions, the refinement instructions are used to annotate the user prompt 402. The annotated user prompt is then input to the generative artificial intelligence form builder 400 through the input interface 404, and the generative artificial intelligence form builder 400 generates a refined form using the annotated user prompt and a refined set of system-provided prompts. In this iterative manner, an authoring user can tune the resulting form to satisfy both substantive and formatting objectives.

In some implementations, the system may provide a dynamic prompt assistant to increase the effectiveness of user prompts. In one such implementation, the input validator receives a user prompt and generates a custom-designed system-provided prompt that is sent with the user prompt to a generative artificial intelligence model to generate a set of follow-up questions that may be helpful in collecting more relevant contextual information from the user. The output of the generative artificial intelligence model can present the follow-up questions (e.g., through a forms web client) in an attempt to solicit supplemental input information and/or corrective input information that is expected to enhance the performance of the generative artificial intelligence form builder 400 and the quality of the generated outcomes.

The principles of input and outcome validation in the described technology can be implemented in a variety of ways. In addition to predicting text from a user's intention, the generative artificial intelligence form builder 400 is sensitive to variations in the prompts input to the machine learning model used to predict such text-minor changes in the prompts can lead to dramatic differences in outcomes, some of which may be considered offensive, biased, non-diverse, confusing, non-engaging, etc. Accordingly, input prompts and/or outcomes may be evaluated within the process flow of the generative artificial intelligence form builder 400, such as to be validated in accordance with Responsible AI objectives. In addition, or in the alternative, the performance of the generative artificial intelligence form builder 400 may be evaluated offline to provide feedback to developers as they maintain and improve the system performance.

In one implementation, for example, system performance may be evaluated using at least two broad categories of metrics: system evaluation metrics and semantic metrics (although other metrics may be employed).
System Evaluation Metrics: An offline evaluation of the outcomes of the generative artificial intelligence form builder 400 can employ basic checks to ensure that the coverage of instructions provided to the system is respected. By evaluating multiple generated outcomes from the generative artificial intelligence form builder 400 based on the same user input (intent), system evaluation metrics can measure whether the instructions provided to the generative artificial intelligence form builder 400 are followed for the same user input (intent), such as adhering to produce a diverse set of questions in outcomes. These metrics were developed keeping in mind the stochastic nature of the generative AI model 412 and contribute to iterative robustification by developers of the generative artificial intelligence form builder 400. Such metrics may also be employed in both input and outcome validation during form generation.
Semantic Metrics: An evaluation of the content of the form/survey generated by the generative artificial intelligence form builder 400 on semantic metrics to ensure that the outcomes (e.g., free form text) generated by the generative AI model 412 match customer expectations and have engaging content from the responder's perspective as well. In one implementation, GPT4 is used in an offline evaluation system to compensate for the lack of human evaluators. Such metrics may also be employed in both input and outcome validation during form generation.

The table below provides examples of system evaluation metrics. In the tables below, GPT and even specific versions of GPT are specified, but it should be understood that other versions and other implementations of generative AI models may be employed.

| Categories | Explanation | Examples of Tested Content |
|---|---|---|
| Question | Check with a rule-based method | \ ″questions\″: [\n {\n \″ id\″; |
| Formatting | on the generated content by the | 1,\n \ ″title\″: \ ″How would you |
| Diversity | form builder system to ensure | rate the ease of use of Microsoft |
| | that questions have diversity in | Azure?\″,\n \ ″type\″: \ |
| | formatting (SingleChoice, | ″Rating\″,\n \ ″answerOptions\″: |
| | MultiChoice, Rating, LongAnswer) | [\n {\ ″text\″: \ ″Difficult\″, \ |
| | | ″value\″: 1},\n {\ ″text\″: \ |
| | | ″Somewhat Difficult\″, \ ″value\″: 2},\n |
| | | {\ ″text\″: \ ″Neutral\″, \ ″value\″: 3},\n |
| | | (\ ″text\″: \ ″Somewhat Easy\″, \ |
| | | ″value\″: 4},\n {\ ″text\″: \ ″Easy\″, |
| | | \ ″value\″: 5}\n ]\n },\n {\n |
| | | \″ id\″: 2,\n \″ title\″: \ ″What |
| | | areas of Microsoft Azure were difficult |
| | | to use?\″,\n \ ″type\″: \ |
| | | ″LongText\″ \n },\n {\n \″ |
| | | id\″: 3,\n \″ title\″: \ ″Were the |
| | | Microsoft Azure documentation and |
| | | tutorials helpful?\″,\n \ ″type\″: \ |
| | | ″SingleChoice\″,\n \ |
| | | ″answerOptions\″: [\n {\ ″text\″: \ |
| | | ″Yes\″},\n {\ ″text\″: \ ″No\″}\n |
| | | ]\n },\n |
| Generation | Checks with a rule-based method | ″‘‘‘\n{\n \″formType\″: \″survey\″,\n |
| Schema | to ensure that the JSON schema | \″formTitle\″: \″Microsoft Azure Product |
| Coverage | is full-proof and has no missing ′{′ | Evaluation\″,\n \″form Description\″: |
| | | \″Thank you for choosing Microsoft |
| | | Azure. We would love to hear your |
| | | thoughts about our product. Your |
| | | feedback will help us improve our |
| | | services to you. Please take a few |
| | | minutes to complete this survey.\″ |
| Refinement | During refinement scenarios, any | |
| Addition | follow-up asks by the user are | |
| Coverage | completed by the GPT | |

| Categories | Explanation | Comments |
|---|---|---|
| Accuracy | GPT4 examines the generated output text and | |
| Coverage | then tries to judge whether there are any | |
| | inaccuracies, missing, or un-factual content | |
| | with respect to the initial user ask (input). | |
| Relevancy | GPT4 examines the generated output text and | |
| Coverage | then tries to judge whether the questions | |
| | across all sections (if present) and the form | |
| | are relevant with respect to the initial user ask | |
| | (input). | |
| Semantic | GPT4 examines the generated output text and | |
| Diversity | then tries to judge whether the questions | |
| Coverage | across all sections (if present) and the form | |
| | are diverse, meaning they are semantically | |
| | different and there are no duplicates. | |
| Cohesion | GPT4 examines the generated output text and | |
| Coverage | then tries to judge whether the questions | |
| | across all sections (if present) and the form | |
| | are fluent and are grammatically correct, | |
| | meaning the title, description, questions, | |
| | options (in case of a single choice, | |
| | multichoice and rating), section titles, and | |
| | section description have no typos or | |
| | grammatical errors. | |
| Fairness | GPT4 examines the generated output text and | |
| (RAI) Score | then tries to judge whether the questions | |
| | across all sections (if present) and the form | |
| | are fair and without any bias that may cause | |
| | any form of discomfort to any section of | |
| | society, especially minority groups. | |
| Audience | GPT4 examines the generated output text and | Here, GPT4 is explicitly told to |
| Understandability | then tries to judge whether the questions | assume the role (personality) |
| Score | across all sections (if present) and the form | of the responder based on |
| | would be understandable by the audience | the initial user ask (input) and |
| | responding to the survey/quiz without any | to judge the content generated |
| | further clarifications. He | by the form builder system |
| | | and rank on understandability. |
| Audience | GPT4 examines the generated output text and | Here, GPT4 is explicitly told to |
| Engagement | then tries to judge whether the questions | assume the role (personality) |
| Score | across all sections (if present) and the form | of the responder based on |
| | would be engaging for the audience | the initial user ask (input) to |
| | responding to the survey/quiz. | judge the content generated |
| | | by the form builder system |
| | | and rank on understandability. |
| Refinement | GPT4 examines the refined (modified) output | |
| Upgrade | text and then tries to determine if the | |
| Score | modified content | |
| Sentiment/ | GPT4 examines the generated output text and | |
| Tone | then tries to identify the sentiment of the | |
| | content by analyzing the questions across all | |
| | sections (if present) and the form. | |
| Refinement | The refinement tonality scores analyze the | |
| Tonality | tone of the refined/modified form and | |
| Score | contribute to scoring relating to whether the | |
| | modification can be deemed satisfactory or | |
| | not. | |

The metrics can be used to rank the generated outcomes with a score, which can then be used to prioritize and guide the iterative development of system-provided prompts, refinement instructions, etc. Furthermore, the metrics may be employed during form generation by the input validator 408 and/or outcome validator 420 to determine whether an input/outcome satisfies the validation parameters (e.g., of Responsible AI or another validation scheme).

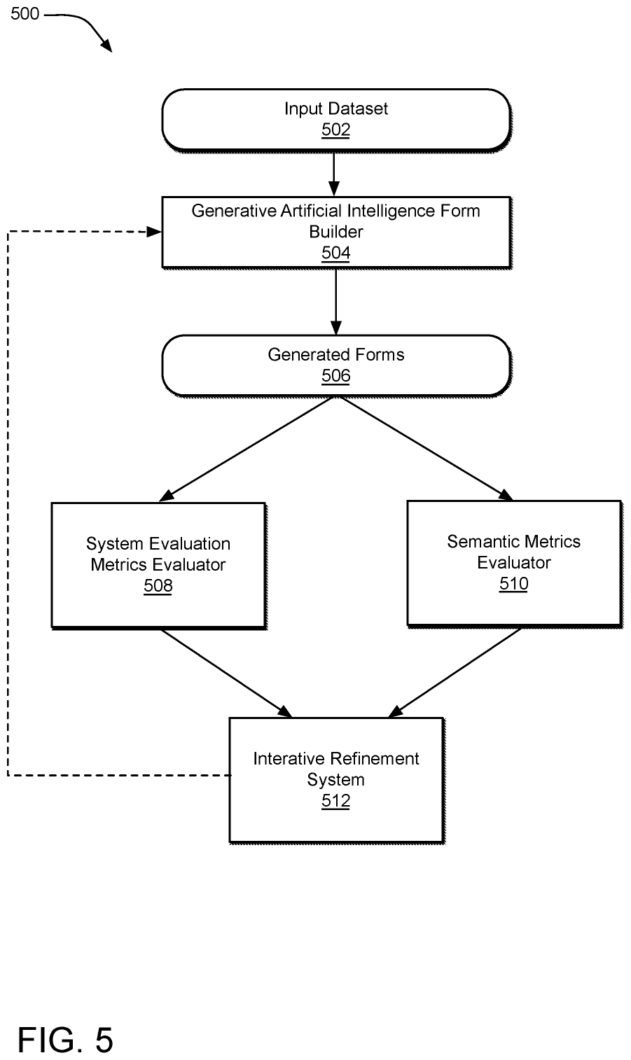

FIG. 5 illustrates an example offline evaluation pipeline 500. An input dataset 502 (e.g., a curated test dataset of user prompts) is input to a generative artificial intelligence form builder 504. In one implementation, this process may be iterative to create multiple generated forms 506, although a single generated form may be employed in some scenarios.

The generated forms 506 may be input to a system evaluation metrics evaluator 508 for measurement, scoring, and ranking of system evaluation metrics (see the table above). Such evaluation may apply rule-based metrics for evaluating basic instruction coverage, among other types of evaluation. Examples of evaluating basic instruction coverage may include evaluating whether the system strictly followed the defined rules, enables refinement, generates valid schema, generates valid question types, etc. The multiple generated forms 506 may also be input to a semantic metrics evaluator 510 for measurement, scoring, and ranking of semantic metrics (see the table above). Such evaluation may apply semantic-based metrics for evaluating the quality of generated form content, among other types of evaluation. Examples of evaluating semantic-based metrics may include evaluating the correctness, diversity, understandability, engagement, and fairness of generated content, as well as evaluating the generated content against Responsible AI or other objectives.

The results of evaluations of the system evaluation metrics and/or the semantic metrics are input to an iterative refinement system 512, which may include developer-implemented and/or automated refinement of program code of the generative artificial intelligence form builder 504 (e.g., by a developer), adjustment of system-provided prompts, adjustment of refinement instructions, etc. in an effort to improve the robustness and valid performance of the generative artificial intelligence form builder 504.

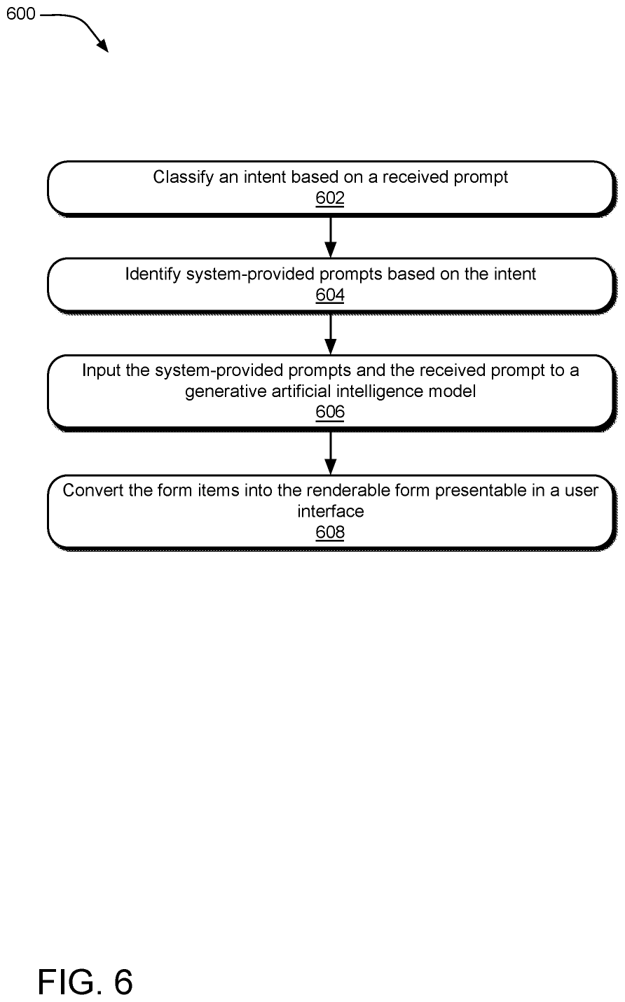

FIG. 6 illustrates example operations 600 for building a renderable form using a generative artificial intelligence form builder. A classifying operation 602 classifies an intent based on a received prompt. In one implementation, an intent classifier employs a large language model to determine the intent of a user prompt, although other techniques may be used to determine an intent (e.g., a look-up table, a similarity measurement, and Retrieval Augmented Generation (RAG)). For example, a similarity measurement may be employed to look-up and categorize user prompts into different intent categories or “buckets.”

Retrieval Augmented Generation (RAG) is an architecture that augments the capabilities of a Large Language Model (LLM), like ChatGPT, by adding an information retrieval system that provides the data. Adding an information retrieval system gives a developer and/or user control over the data used by an LLM when it formulates a response. For an enterprise solution, RAG architecture means that natural language processing can be constrained to intended content (e.g., an enterprise's proprietary content) sourced from vectorized documents, images, audio, and video.

A prompt identifying operation 604 identifies system-provided prompts based on the intent. For example, a system prompt constructor can look-up system-provided prompts in a prompt template library or generate system-provided prompts using a generative artificial intelligence model. In one implementation, the prompt identifying operation 604 searches a prompt template library based on the intent and identifies the system-provided prompts that correspond to the intent. In another implementation, the prompt identifying operation 604 generates the system-provided prompts based on the intent using a generative artificial intelligence model. Other methods of developing system-provided prompts corresponding to the intent may be employed.

A form item generating operation 606 inputs the system-provided prompts and the received prompt to a generative artificial intelligence model, which outputs form items corresponding to the received prompt and the system-provided prompts. The form items include form prompt items and form response items. A schema generating operation 608 converts the form items into the renderable form presentable in a user interface, wherein the renderable form includes the form prompt items and the form response items. The renderable form is, therefore, recordable in memory and/or storage as a generated form schema (e.g., in JSON format). In some implementations, the form items include formatting items that inform the schema generating operation 608 to apply formatting parameters in the renderable form.

In some implementations, the building of a renderable form using a generative artificial intelligence form builder may also include an input validating operation that validates the received prompt for compliance with a predefined policy prior to inputting the system-provided prompts and the received prompt to the generative artificial intelligence model.

In some implementations, the building of a renderable form using a generative artificial intelligence form builder may also include a form item validating operation that validates the form prompt items and form response items for compliance with a predefined policy and excludes at least one form prompt item and at least one form response item from the renderable form as non-compliant with the predefined policy. In this manner, non-compliant form items are not provided in the generated form.

In some implementations, the building of a renderable form using a generative artificial intelligence form builder may also include an operation of receiving a refinement instruction relating to the renderable form and an operation of submitting the refinement instruction to the generative artificial intelligence model. The generative artificial intelligence model outputs refined form items corresponding at least in part to the refinement instruction. The refined form items may include refined form prompt items and refined form response items. The building process may include another operation of converting the refined form items into a refined renderable form presentable in a user interface, wherein the refined renderable form includes the refined form prompt items and the refined form response items.

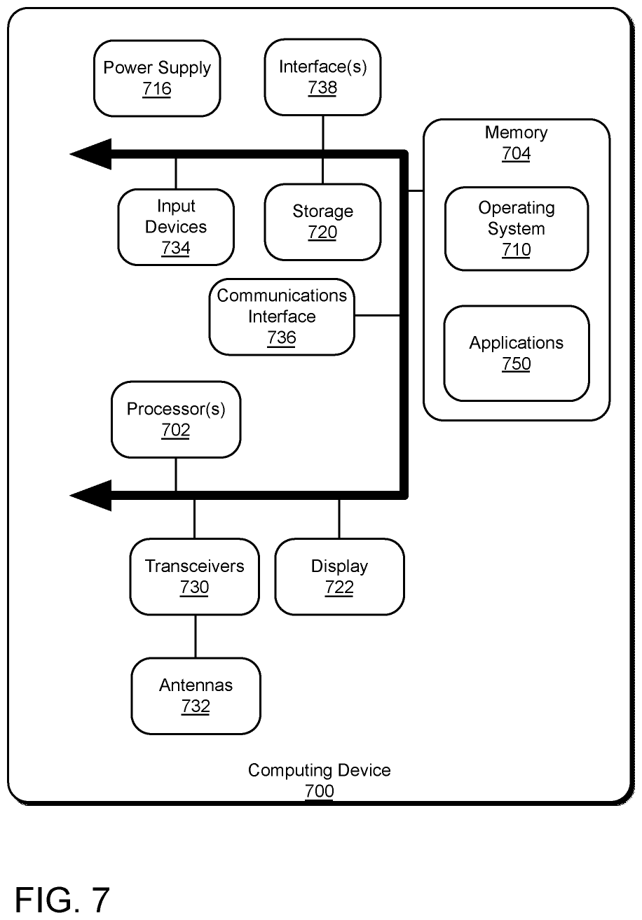

FIG. 7 illustrates an example computing device 700 for use in implementing the described technology. The computing device 700 may be a client computing device (such as a laptop computer, a desktop computer, or a tablet computer), a server/cloud computing device, an Internet-of-Things (IoT), any other type of computing device, or a combination of these options. The computing device 700 includes one or more hardware processor(s) 702 and a memory 704. The memory 704 generally includes both volatile memory (e.g., RAM) and nonvolatile memory (e.g., flash memory), although one or the other type of memory may be omitted. An operating system 710 resides in the memory 704 and is executed by the processor(s) 702. In some implementations, the computing device 700 includes and/or is communicatively coupled to storage 720.

In the example computing device 700, as shown in FIG. 7, one or more modules or segments, such as applications 750, an input interface, an input processing system, an input validator, an intent classifier, various generative AI models and/or large language models, a system prompt constructor, an outcome validator, a schema generator, a rendering engine, and other program code and modules are loaded into the operating system 710 on the memory 704 and/or the storage 720 and executed by the processor(s) 702. The storage 720 may store user prompts, a prompt template library, system-provided prompts, intents, form schemas, format items, formatting parameters, and other data and be local to the computing device 700 or may be remote and communicatively connected to the computing device 700. In particular, in one implementation, components of a system for generating a renderable form may be implemented entirely in hardware or in a combination of hardware circuitry and software.

The computing device 700 includes a power supply 716, which may include or be connected to one or more batteries or other power sources, and which provides power to other components of the computing device 700. The power supply 716 may also be connected to an external power source that overrides or recharges the built-in batteries or other power sources.

The computing device 700 may include one or more communication transceivers 730, which may be connected to one or more antenna(s) 732 to provide network connectivity (e.g., mobile phone network, Wi-Fi®, Bluetooth®) to one or more other servers, client devices, IoT devices, and other computing and communications devices. The computing device 700 may further include a communications interface 736 (such as a network adapter or an I/O port, which are types of communication devices). The computing device 700 may use the adapter and any other types of communication devices for establishing connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard, trackpad, or mouse). These and other input devices may be coupled to the server by one or more interfaces 738, such as a serial port interface, parallel port, or universal serial bus (USB). The computing device 700 may further include a display 722, such as a touchscreen display.

The computing device 700 may include a variety of tangible processor-readable storage media and intangible processor-readable communication signals. Tangible processor-readable storage can be embodied by any available media that can be accessed by the computing device 700 and can include both volatile and nonvolatile storage media and removable and non-removable storage media. Tangible processor-readable storage media (and/or tangible processor-readable storage media) excludes intangible communications signals (such as signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 700. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of generating a renderable form, the method comprising: classifying an intent based on a received prompt; identifying system-provided prompts based on the intent; inputting the system-provided prompts and the received prompt to a generative artificial intelligence model, wherein the generative artificial intelligence model outputs form items corresponding to the received prompt and the system-provided prompts, the form items including form prompt items and form response items; and converting the form items into the renderable form presentable in a user interface, wherein the renderable form includes the form prompt items and the form response items.

Clause 2. The method of clause 1, wherein the identifying comprises: searching a prompt template library based on the intent; and identifying the system-provided prompts that correspond to the intent.

Clause 3. The method of clause 1, wherein the identifying comprises: generating the system-provided prompts based on the intent.

Clause 4. The method of clause 1, wherein the form items include formatting items that inform the converting to include formatting parameters applied to the renderable form.

Clause 5. The method of clause 1, further comprising: validating the received prompt for compliance with a predefined policy prior to inputting the system-provided prompts and the received prompt to the generative artificial intelligence model.

Clause 6. The method of clause 1, further comprising: validating the form prompt items and the form response items for compliance with a predefined policy; and excluding at least one form prompt item and at least one form response item from the renderable form as non-compliant with the predefined policy.

Clause 7. The method of clause 1, wherein the renderable form is represented by a generated form schema configured to be rendered by a rendering engine.

Clause 8. The method of clause 1, further comprising: receiving a refinement instruction relating to the renderable form; submitting the refinement instruction to the generative artificial intelligence model, wherein the generative artificial intelligence model outputs refined form items corresponding at least in part to the refinement instruction, the refined form items including refined form prompt items and refined form response items; and converting the refined form items into a refined renderable form presentable in the user interface, wherein the refined renderable form includes the refined form prompt items and the refined form response items.

Clause 9. A system for generating a renderable form, the system comprising: one or more hardware processors; an intent classifier executable by the one or more hardware processors and configured to classify an intent based on a received prompt; a system prompt constructor executable by the one or more hardware processors and configured to identify system-provided prompts based on the intent, wherein the system-provided prompts and the received prompt are input to a generative artificial intelligence model, wherein the generative artificial intelligence model outputs form items corresponding to the system-provided prompts, the form items including form prompt items and form response items; and a schema generator executable by the one or more hardware processors and configured to convert the form items into the renderable form presentable in a user interface, wherein the renderable form includes the form prompt items and the form response items.

Clause 10. The system of clause 9, wherein the system prompt constructor is further configured to search a prompt template library based on the intent and to identify the system-provided prompts that correspond to the intent.

Clause 11. The system of clause 9, wherein the system prompt constructor is further configured to generate the system-provided prompts based on the intent.

Clause 12. The system of clause 9, wherein the form items include formatting items that inform the converting to include formatting parameters applied to the renderable form.

Clause 13. The system of clause 9, further comprising an input validator executable by the one or more hardware processors and configured to validate the received prompt for compliance with a predefined policy prior to inputting the system-provided prompts and the received prompt to the generative artificial intelligence model based on semantic metrics or system evaluation metrics.

Clause 14. The system of clause 9, further comprising an output validator executable by the one or more hardware processors and configured to validate the form prompt items and the form response items for compliance with a predefined policy based on semantic metrics or system evaluation metrics and to exclude at least one form prompt item and at least one form response item from the renderable form as non-compliant with the predefined policy.

Clause 15. One or more tangible processor-readable storage media embodied with instructions for executing on one or more processors and circuits of a computing device a process for generating a renderable form, the process comprising: classifying an intent based on a received prompt; identifying system-provided prompts based on the intent; inputting the system-provided prompts and the received prompt to a generative artificial intelligence model, wherein the generative artificial intelligence model outputs form items corresponding to the received prompt and the system-provided prompts; and converting the form items into the renderable form presentable in a user interface, wherein the renderable form includes the form prompt items.

Clause 16. The one or more tangible processor-readable storage media of clause 15, wherein the identifying comprises: searching a prompt template library based on the intent; and identifying the system-provided prompts that correspond to the intent.

Clause 17. The one or more tangible processor-readable storage media of clause 15, wherein the identifying comprises: generating the system-provided prompts based on the intent.

Clause 18. The one or more tangible processor-readable storage media of clause 15, further comprising: validating the form prompt items and form response items for compliance with a predefined policy; and excluding at least one form prompt item and at least one form response item from the renderable form as non-compliant with the predefined policy.

Clause 19. The one or more tangible processor-readable storage media of clause 15, wherein the renderable form is represented by a generated form schema configured to be rendered by a rendering engine.

Clause 20. The one or more tangible processor-readable storage media of clause 15, further comprising: receiving a refinement instruction relating to the renderable form; submitting the refinement instruction to the generative artificial intelligence model, wherein the generative artificial intelligence model outputs refined form items corresponding at least in part to the refinement instruction, the refined form items including refined form prompt items and refined form response items; and converting the refined form items into a refined renderable form presentable in the user interface, wherein the refined renderable form includes the refined form prompt items and the refined form response items.

Clause 21. A system for generating a renderable form, the system comprising: means for classifying an intent based on a received prompt; means for identifying system-provided prompts based on the intent; means for inputting the system-provided prompts and the received prompt to a generative artificial intelligence model, wherein the generative artificial intelligence model outputs form items corresponding to the received prompt and the system-provided prompts, the form items including form prompt items and form response items; and means for converting the form items into the renderable form presentable in a user interface, wherein the renderable form includes the form prompt items and the form response items.

Clause 22. The system of clause 21, wherein the means for identifying comprises: means for searching a prompt template library based on the intent; and means for identifying the system-provided prompts that correspond to the intent.

Clause 23. The system of clause 21, wherein the means for identifying comprises: means for generating the system-provided prompts based on the intent.

Clause 24. The system of clause 21, wherein the form items include means for formatting items that inform the converting to include formatting parameters applied to the renderable form.

Clause 25. The system of clause 21, further comprising: means for validating the received prompt for compliance with a predefined policy prior to inputting the system-provided prompts and the received prompt to the generative artificial intelligence model.

Clause 26. The system of clause 21, further comprising: means for validating the form prompt items and the form response items for compliance with a predefined policy; and means for excluding at least one form prompt item and at least one form response item from the renderable form as non-compliant with the predefined policy.

Clause 27. The system of clause 21, wherein the renderable form is represented by a generated form schema configured to be rendered by a rendering engine.

Clause 28. The system of clause 21, further comprising: means for receiving a refinement instruction relating to the renderable form; means for submitting the refinement instruction to the generative artificial intelligence model, wherein the generative artificial intelligence model outputs refined form items corresponding at least in part to the refinement instruction, the refined form items including refined form prompt items and refined form response items; and means for converting the refined form items into a refined renderable form presentable in the user interface, wherein the refined renderable form includes the refined form prompt items and the refined form response items.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

1. A method of generating a renderable form, the method comprising:
classifying an intent based on a received prompt;
identifying system-provided prompts based on the intent;
inputting the system-provided prompts and the received prompt to a generative artificial intelligence model, wherein the generative artificial intelligence model outputs form items corresponding to the received prompt and the system-provided prompts, the form items including form prompt items and form response items; and
converting the form items into the renderable form presentable in a user interface, wherein the renderable form includes the form prompt items and the form response items.

2. The method of claim 1, wherein the identifying comprises:
searching a prompt template library based on the intent; and
identifying the system-provided prompts that correspond to the intent.

3. The method of claim 1, wherein the identifying comprises:
generating the system-provided prompts based on the intent.

4. The method of claim 1, wherein the form items include formatting items that inform the converting to include formatting parameters applied to the renderable form.

5. The method of claim 1, further comprising:
validating the received prompt for compliance with a predefined policy prior to inputting the system-provided prompts and the received prompt to the generative artificial intelligence model.

6. The method of claim 1, further comprising:
validating the form prompt items and the form response items for compliance with a predefined policy; and
excluding at least one form prompt item and at least one form response item from the renderable form as non-compliant with the predefined policy.

7. The method of claim 1, wherein the renderable form is represented by a generated form schema configured to be rendered by a rendering engine.

8. The method of claim 1, further comprising:
receiving a refinement instruction relating to the renderable form;
submitting the refinement instruction to the generative artificial intelligence model, wherein the generative artificial intelligence model outputs refined form items corresponding at least in part to the refinement instruction, the refined form items including refined form prompt items and refined form response items; and
converting the refined form items into a refined renderable form presentable in the user interface, wherein the refined renderable form includes the refined form prompt items and the refined form response items.

9. A system for generating a renderable form, the system comprising:
one or more hardware processors;
an intent classifier executable by the one or more hardware processors and configured to classify an intent based on a received prompt;
a system prompt constructor executable by the one or more hardware processors and configured to identify system-provided prompts based on the intent, wherein the system-provided prompts and the received prompt are input to a generative artificial intelligence model, wherein the generative artificial intelligence model outputs form items corresponding to the system-provided prompts, the form items including form prompt items and form response items; and
a schema generator executable by the one or more hardware processors and configured to convert the form items into the renderable form presentable in a user interface, wherein the renderable form includes the form prompt items and the form response items.

10. The system of claim 9, wherein the system prompt constructor is further configured to search a prompt template library based on the intent and to identify the system-provided prompts that correspond to the intent.

11. The system of claim 9, wherein the system prompt constructor is further configured to generate the system-provided prompts based on the intent.

12. The system of claim 9, wherein the form items include formatting items that inform the schema generator to include formatting parameters applied to the renderable form.

13. The system of claim 9, further comprising:
an input validator executable by the one or more hardware processors and configured to validate the received prompt for compliance with a predefined policy prior to inputting the system-provided prompts and the received prompt to the generative artificial intelligence model based on semantic metrics or system evaluation metrics.

14. The system of claim 9, further comprising:
an output validator executable by the one or more hardware processors and configured to validate the form prompt items and the form response items for compliance with a predefined policy based on semantic metrics or system evaluation metrics and to exclude at least one form prompt item and at least one form response item from the renderable form as non-compliant with the predefined policy.

15. One or more tangible processor-readable storage media embodied with instructions for executing on one or more processors and circuits of a computing device a process for generating a renderable form, the process comprising:
classifying an intent based on a received prompt;
identifying system-provided prompts based on the intent;
inputting the system-provided prompts and the received prompt to a generative artificial intelligence model, wherein the generative artificial intelligence model outputs form items corresponding to the received prompt and the system-provided prompts; and
converting the form items into the renderable form presentable in a user interface, wherein the renderable form includes the form prompt items.

16. The one or more tangible processor-readable storage media of claim 15, wherein the identifying comprises:
searching a prompt template library based on the intent; and
identifying the system-provided prompts that correspond to the intent.

17. The one or more tangible processor-readable storage media of claim 15, wherein the identifying comprises:
generating the system-provided prompts based on the intent.

18. The one or more tangible processor-readable storage media of claim 15, further comprising:
validating the form prompt items and form response items for compliance with a predefined policy; and
excluding at least one form prompt item and at least one form response item from the renderable form as non-compliant with the predefined policy.

19. The one or more tangible processor-readable storage media of claim 15, wherein the renderable form is represented by a generated form schema configured to be rendered by a rendering engine.

20. The one or more tangible processor-readable storage media of claim 15, further comprising:
receiving a refinement instruction relating to the renderable form;
submitting the refinement instruction to the generative artificial intelligence model, wherein the generative artificial intelligence model outputs refined form items corresponding at least in part to the refinement instruction, the refined form items including refined form prompt items and refined form response items; and
converting the refined form items into a refined renderable form presentable in the user interface, wherein the refined renderable form includes the refined form prompt items and the refined form response items.

21. The method of claim 1, wherein classifying the intent based on the received prompt comprises:
predicting the intent of the received prompt by generating a predefined textual response conditioned on the received prompt using a large language model.
